(19) United States
(12) Patent Application Publication
(10) Pub. No.: US 2005/0119426 A1
(43) Pub. Date: Jun. 2, 2005

(54) High molecular weight HDPE resins

(76) Inventors: Scott Thomas Roger, Houston, TX (US); Thomas W. Towles, Baton Rouge, LA (US); Anthony Nicholas Speca, Kingwood, TX (US); Stanley J. Katzen, Baton Rouge, LA (US)

Correspondence Address: ExxonMobil Chemical Company;Law Technology, P.O. Box 2149, Baytown, TX, 77522-2149, US

(21) Appl. No.: 10/973,805

(22) Filed: Oct. 25, 2004

(30) Foreign Application Priority Data
Oct. 31, 2003 (WO) PCT/US03/34679

(51) Int. Cl. C08F 2/00

(52) U.S. Cl. 526/113; 526/114; 526/64; 526/348.5

(57) ABSTRACT

This invention is related to a polyethylene resin particularly suitable for large parts by blow molding and/or sheet extrusion/thermoforming procedures, wherein the resin is made by a process using an activated chromium and titanium-based catalyst.

### FIELD OF THE INVENTION

This invention is related to a method of producing a high molecular weight HDPE particularly suitable for blow molding and sheet extrusion/thermoforming applications, such as manufacture of large parts.

### BACKGROUND

High molecular weight, high density polyethylene (HMW HDPE) is used to manufacture storage containers, such as large industrial drums (e.g., 30- and 55- gallons) and intermediate bulk containers (IBC) such as 100- and 300-gallon containers. HMW HDPE is also used in sheet extrusion/thermoforming operations to produce large parts such as truck bed liners, “port-a-potties” or portable toilets, and “dunnage trays” for holding and transporting large industrial parts such as transmissions. The end user expects—and governmental regulations often require —that the container meet certain minimum requirements, such as for impact resistance, top load, Environmental Stress Crack Resistance (ESCR), and chemical resistance. In addition, the manufacturer of the containers expect ease of processability. Depending on the end use, there may be even more specific requirements of the material. For instance, in the case of large drums manufactured by blow molding, a high melt strength is generally desired, as the parison produced in the blow molding process typically must maintain its integrity for longer periods of time as the object made gets larger.

In the development of resin there is typically a trade off between characteristics such as resistance to slow crack growth and rupture (measured, for instance, by Environmental Stress Crack Resistance or ESCR), stiffness (measured, for instance, by density) and processability (measured, for instance, by melt index or MI). Typically the higher the molecular weight of polyethylene, the higher the resistance to crack growth. However, increasing the molecular weight will decrease processability and make blow molding more difficult.

Chromium catalysts are well known catalysts for olefin polymerization and are useful in preparing HMW HDPE. In these catalysts, a chromium compound, such as chromium oxide, is supported on a support of one or more inorganic oxides such as silica, alumina, zirconia or thoria, and activated by heating in a non-reducing atmosphere. U.S. Pat. No. 2,825,721 describes chromium catalysts and methods of making the catalysts. It is also known to increase polymer melt index by using a silica-titania support as disclosed, for example, in U.S. Pat. No. 3,887,494. Numerous activation procedures have been described in the prior art for optimizing catalyst performance and resultant ethylene polymer characteristics, such as U.S. Pat. Nos. 4,981,831; 5,093,300; 5,895,770; 6,150,572; 6,201,077; 6,204,346; 6,214,947; 6,359,085; and 6,569,960; U.S. Patent Application Nos. 2001/0004663 and 2001/0007894; EP 1038 886 Al; EP 0 882 740 Al; EP 0 882 743 Al; EP 0905148; and WO 00/14129.

What is needed is a resin in particular having a high ESCR, good stiffness, and excellent processing characteristics, produced by a process that preferably can employ a commercially available catalyst, and wherein the activated catalyst has high activity and long life.

The present inventors have discovered a method of making a resin particularly suitable for large part blow molding applications, particularly drums, IBCs, and sheet extrusion/thermoforming parts, having high ESCR, high impact resistance, high stiffness, and good processability, using a chromium and titanium-based supported catalyst activated in a simple manner so as to provide for high activity, and long catalyst life, said catalyst being commercially available.

Embodiments of the present invention may have the advantage over previously known methods of producing blow molding HDPE by having an improved ESCR versus density relationship, yet maintaining good processing and stiffness characteristics.

### SUMMARY OF THE INVENTION

It is an object of this invention to provide a process to polymerize ethylene, or ethylene and at least one other olefin, particularly an alpha olefin, and even more particularly an alpha olefin comprising 3 to 10 carbon atoms, to produce a polymer particularly suitable for the large part molding market, (e.g., blow molding, sheet extrusion/thermoforming especially in the production of containers such as 30- and 55-gallon drums and IBCs.

It is also an object of this invention to provide said polymer in an efficient manner using a catalyst activated for polymerization so as to provide for a higher ESCR versus density performance, high activity, and long catalyst life.

It is still a further object of this invention to provide articles such as large industrial containers, particularly 30- and 55-gallon drums, IBCs, and sheet extrusion/thermoforming parts from the resin produced according to the present invention.

Yet still further an object of the invention is to provide an activated catalyst for the manufacture of blow molding resin.

In certain embodiments, the invention provides polyethylene resins produced by the inventive process, and articles formed of such resins. Typical articles include, for example, containers for the shipping of large industrial parts, and industrial bulk containers such as drums (e.g., 30- and 55-gallon drums), and the like, and 100-, 300-, and 400-gallon IBCs, and the like.

These and other objects, features, advantages, and embodiments of the present invention will become apparent as reference is made to the following detailed description, additional embodiments, specific examples, and appended claims.

### DETAILED DESCRIPTION

In an embodiment, the support is a silica-titania support. Silica-titania supports are well known in the art and are described, for example, in U.S. Pat. No. 3,887,494. Silica-titania supports can be produced as described in U.S. Pat. Nos. 3,887,494, 5,096,868 or 6,174,981 by “cogelling” or coprecipitating silica and a titanium compound. Such a cogel can be produced by contacting an alkali metal silicate such as sodium silicate with an acid such as sulfuric acid, hydrochloric acid or acetic acid, or an acidic salt. The titanium component can be conveniently dissolved in the acid or alkali metal silicate solution and co-precipitated with the silica. The titanium compound can be incorporated in the acid in any form in which it subsequently will be incorporated in the silica gel formed on combination of the silicate and the acid and from which form it is subsequently convertible to titanium oxide on calcination. Suitable titanium compounds include, but are not limited to, halides such as TiCl₃ and TiC4, nitrates, sulfates, oxalates and alkyl titanates. In instances where carbon dioxide is used as the acid, the titanium can be incorporated into the alkali metal silicate itself. When using acidic salts, the titanium compound can be incorporated in the alkali metal silicate and in such instances, convenient titanium compounds are water soluble materials which do not precipitate the silicate, i.e., are those convertible to titanium oxide on calcination such as, for example, various titanium oxalates, such as K₂TiO(C₂0₄)₂ H₂0, (NH₄)₂TiO(C₂0₄)₂ H₂O and Ti₂(C₂0₄)₃-H₂0. As used herein, the term “silica-titania” support includes supports formed by any of these coprecipitation or cogel processes, or other processes by which titania and silica are both incorporated into the support.

In another embodiment, titanium is incorporated by surface-modifying a supported chromium catalyst. As used herein, the term “titanium surface-modified supported chromium catalyst” is meant to include any supported chromium catalyst that is further modified to include titanium; see, e.g., C.E. Marsden, Plastics, Rubber and Composites Processing and Applications, 21 (1994), 193-200. For example, it is known to modify supported chromium catalysts by slurrying the chromium catalyst in a hydrocarbon and contacting the slurry with a titanium alkoxide, Ti(OR)₄, and heating to form a dried, titanium surface-modified supported chromium catalyst. The alkyl group R of the alkoxide can be a C₃ to C₈ linear or branched alkyl group; a particular example of a suitable titanium alkoxide is titanium tetraisopropoxide.

The titanium compound preferably is generally present in an amount of from a lower limit of 0.5% or 1% or 2% by weight to an upper limit of 12% or 10% or 8% or 6% or 5% or 4% or 3% by weight, with ranges from any lower limit to any upper limit being contemplated. It is preferred that the amount of titanium be in the range of 1.0 wt. % to 5.0 wt. %, more preferably 1.5 wt. % to 4.5 wt. % (3.0±1.5 wt. %). In an embodiment, the even more preferable range is 2.5±0.5 wt. %.

The chromium compound can be incorporated in any convenient method known in the art. For example, a chromium compound and optionally a titanium compound, is dissolved in an acidic material or the silicate and thus coprecipitated with the silica. A suitable chromium compound for this method is chromic sulfate. Another method to incorporate a chromium compound into the catalyst system is to use a hydrocarbon solution of a chromium compound convertible to chromium oxide to impregnate the support after it is spray dried or azeotrope dried (i.e., a xerogel). Exemplary of such materials are t-butyl chromate, chromium acetylacetonate, and the like. Suitable solvents include, but are not limited to, pentane, hexane, benzene, and the like. Alternatively, an aqueous solution of a chromium compound simply can be physically mixed with the support. These types of catalyst systems are disclosed in U.S. Pat. No. 3,887,494.

Chromium can be present in the catalyst an amount from a lower limit of 0.1 or 0.5 or 0.8 or 1.0% by weight to an upper limit of 10% or 8% or 5% or 4% or 3% or 2% by weight, with ranges from any lower limit to any upper limit being contemplated. The preferred amount of chromium is about 1.0±0.5 wt. %, particularly when the process utilizes the slurry loop platform, discussed more fully below.

Other inorganic oxides may optionally be present, such as thoria, zirconia, boron oxide, alumina, and the like, but in a preferred embodiment, with regard to inorganic oxides other than that of the silica support, only the oxides of chromium and titanium are present to the extent provided by ordinary purification techniques. In another embodiment, additional metals are permissible provided they do not materially affect the basic characteristics of the catalyst or the activation procedure according to the present invention.

The weight percent of the aforementioned metals are based on the weight of the support, e.g, silica in the preferred embodiment.

Catalysts as described above which are useful in the present invention are commercially available, such as The PQ Corporation, W.R. Grace and Company, and Ineos Silicas Americas, LLC.

The catalyst treated by the process according to the present invention comprises chromium and titanium on a support. Typically the catalyst used in the process according to the present invention will be a commercial supported catalyst that may have hydrocarbon residues deposited thereon. A beneficial hydrocarbon treatment has been described previously and used in activating catalysts for producing utility conduit resin and extruded pipe resin, in PCT/US03/09871, PCT/US03/09869 and PCT/US03/09870, respectively. It is highly surprising that such treatment could be useful in producing resin for blow molding and sheet extrusion/thermoforming applications.

In an embodiment described herein, the chromium and titanium-based supported catalyst to be treated by the method described herein has hydrocarbon residues deposited thereon. “Hydrocarbon residues” as used herein means any species or moiety containing hydrogen and carbon, which is present on the catalyst and/or support. Without limitation, such hydrocarbon residues may be present on the catalyst and/or support as a result of having been deposited during the manufacture of the catalyst or support, such as organic solvent residues or by the deposition of one or more of chromium, titanium, zirconium, aluminum, and boron on the support from an organic solution (e.g., chromium acetate), such as described in the previously mentioned U.S. Pat. No. 5,895,770. Hydrocarbon residues may also be present in supported catalysts comprising chromium and/or titanium made by gel processes such as in the cogel and tergel catalysts described previously.

As used herein, the terms “chromium and titanium-based supported catalyst” is intended to distinguish the catalyst according to the present invention from a “chromium-based catalyst” which does not contain titanium.

Chromium and titanium and optional species, if present, may have been deposited from solution and hydrocarbon residues are present at least in part as a result of this deposition process (e.g., hydrocarbon residues may be from the solvent or metal counter ion). Hydrocarbon residues may also be present as a result of the manufacture or processing of the support.

The chromium and titanium-based supported catalyst according to the present invention is then placed in an activating reactor to be treated by the process according to the present invention. The invention may be practiced using any known method for bringing gases and solids into contact with each other, such as in a static bed or a fluidizing bed. The term activating reactor is not intended to be limiting with respect to equipment design or configuration, and the terms “activator” and “activating reactor” are used interchangably herein for convenience. Advantageously the activating reactor will be a fluidized bed reactor.

The activating reactor may be heated by, for instance, internal activator reactor rods, by an external source of heat applied to the activating reactor walls, such as electrical heat or by heat of combustion, by provision for heating the gas entering the activating reactor via one or more gas inlet valves, or by a combination of such heating sources, all of which can be measured and controlled by means per se well known.

It should be noted that, as used herein, “activator temperature” is typically measured at or very close to the catalyst bed and thus, as would be understood by one of skill in the art, “activator temperature” is taken as surrogate for the temperature of the catalyst.

The catalyst used in the process according to the present invention is a chromium and titanium-based supported catalyst activated in activator at about 370-540° C. (700-1000° F.), preferably 370-450° C. (700-850° F.), more preferably 370-425° C. (700-800° F.), still more preferably 370 to 400° C. (700-750° F.), under an inert atmosphere, followed by the introduction of an oxidant, preferably in the form of air, and controlling the reactor temperature so that the temperature of the catalyst activator does not exceed 510° C. (950° F.), preferably no higher than about 480° C. (900° F.), and yet still more preferably no higher than about 450° C. (850° F.), most preferably no higher than about 425° C. (800° F.).

In another embodiment the activator temperature is controlled by the rate of addition of oxygen and by the temperature of the gas entering the activator. Thus, the present invention also includes a process for polymerizing ethylene including treating a chromium and titanium-containing supported catalyst at about 370-400° C. (700-750° F.) under an inert atmosphere which may be at least partially preheated to a temperature higher or lower than the activating reactor temperature, followed by the controlled introduction of an oxidant, preferably in the form of air, which has been preheated to a temperature no greater than about 400° C. (750° F.), most preferably by air which has been preheated to about 200° C. (400° F.) or less, while controlling the temperature spike so that the temperature of the catalyst activator does not exceed 510° C. (950° F.), preferably no higher than about 480° C. (900° F.), and yet still more preferably no higher than about 450° C. (850° F.), most preferably no higher than about 425° C. (800° F.).

In another embodiment of the invention, in addition to the temperature hold period described above, additional hold periods at temperatures lower than 370° C. (700° F.) are contemplated. Thus in one embodiment the activator temperature is ramped up from room temperature to about 205° C.±25° C. (400° F.±45° F.) at about 220° C./hr (400 F/hr) and held at this temperature under a nitrogen atmosphere for a period of one minute to up to about 6 hours, or even more, followed by a temperature ramp up to a preselected temperature between about 370-540° C. (700-1000° F.), preferably 370-450° C. (700-850° F.), more preferably 370-425° C. (700-800° F.), still more preferably 370 to 400° C. (700-750° F.), at a rate of about 200° C./hr (350° F./hr), while still under an inert atmosphere. This temperature and inert atmosphere is then held constant for a period of from one minute up to about 6 hours. Even greater hold periods are possible, however the benefits, if any, are generally offset by the greater cost.

The nitrogen (or inert gas) treatment may occur to an even higher temperature, however (without wishing to be bound by theory) it is believed that above about 540° C. (1000° F.) the supported chromium and titanium catalyst may be converted partially or wholly into a form (“green batch”) which is less amenable to a subsequent treatment with oxygen. A green batch may also be observed under conditions where the oxygen is present at a concentration of less than about 20% by volume, i.e., less oxygen than is normally present in air. Thus temperatures of above about 540° C. should be avoided during the treatment under pure nitrogen or other inert gaseous treatment and during conditions where pure nitrogen is mixed with air.

Activation may then be completed by contacting the catalyst in the activating reactor with an oxidizing atmosphere, preferably an atmosphere consisting essentially of air. The final temperature of the activating reactor under an oxidizing atmosphere, preferably an atmosphere consisting essentially of air, is 548-638° C. (1020-1180° F.), for a period of from 1 minute to 10 hours, preferably 3.5 to 8 hours, more preferably 4 to 7 hours and yet still more preferably 6 hours. While a treatment at this temperature for more than 6 hours is possible, the advantages, if any, are typically offset by the cost.

The final activation hold temperature is a key to the blow molding resin according to the present invention. A lower final hold temperature yields a polymer having a better ESCR but its activity will be too low for economical polymerization reactor operation, while a higher final hold temperature yields improved polymerization reactor performance but without adequate ESCR.

It should be noted that, as used herein, “activating reactor temperature” or “activator temperature” is typically measured at or very close to the catalyst bed and thus, as would be understood by one of skill in the art, “activating reactor temperature” or “activator” is taken as surrogate for the temperature of the catalyst.

The thus-activated supported chromium and titanium-based catalyst is then preferably cooled to about 150-315° C. (300-600° F.), purged with nitrogen while cooling to room temperature and then used as desired.

The ethylene used in the polymerization process should be polymerization grade ethylene. The other olefins that can be used are alpha-olefins having from 3 to 10 carbon atoms. Numerous acceptable alpha-olefins will be apparent to one of ordinary skill in the art in possession of the present disclosure. The preferred olefins to be copolymerized are 1-butene, 1-hexene, and 1-octene.

The resin according to the invention can be polymerized using any known process in the art for producing HDPE, such as gas phase, solution or slurry polymerization conditions. A stirred polymerization reactor can be utilized for a batch or continuous process, or the reaction can be carried out continuously in a loop reactor.

In an embodiment, the polymerization occurs in a slurry loop reactor under slurry polymerization conditions. One of ordinary skill in the art, in possession of the present disclosure, can determine the appropriate slurry polymerization conditions. Loop reactors are known in the art, see, for example, U.S. Pat. Nos. 3,248,179; 4,424,341; 4,501,855; 4,613,484; 4,589,957; 4,737,280; 5,597,892; and 5,575,979; 6,204,344; 6,281,300; 6,319,997; and 6,380,325.

The resin of the invention is preferably produced in a slurry reactor, such as a stirred slurry reactor or a slurry loop reactor. For illustrative purposes, the methods are described below with particular reference to a slurry loop reactor. However, it should be appreciated that the methods are not limited to this particular polymerization reactor configuration.

A slurry loop olefin polymerization reactor can generally be described as a loop-shaped continuous pipe. One or more fluid circulating devices, such as an axial flow pump, circulate the reactor contents within the pipe in a desired direction so as to create a circulating current or flow of the reactor contents within the pipe. Desirably, the fluid circulating devices are designed to provide high velocity. The loop reactor may be totally or partially jacketed with cooling water in order to remove heat generated by polymerization.

In the slurry loop olefin polymerization reactor, the polymerization medium includes monomer, optional comonomer and minor quantities of other additives, as known in the art, and a hydrocarbon carrier or diluent, advantageously aliphatic paraffin such as propane, butane, isobutane, isopentane, or mixtures thereof. Actual temperature and pressure conditions will depend on various parameters such as the carrier or diluent, as would be known by one of ordinary skill in the art. Additional description is given in numerous patents, including U.S. Pat. Nos. 5,274,056 and 4,182,810 and PCT publication WO 94/21962.

The slurry loop olefin polymerization reactor may be operated in a single stage process or in multistage processes. In multistage processing, the polymerization of olefins is carried out in two or more polymerization reactors. These polymerization reactors can be configured in series, in parallel, or a combination thereof. U.S. Pat. No. 6,380,325 sets forth a two stage flash process which is a preferred platform to practice the present invention.

The resin according to the present invention may be produced using the catalyst treated according to the processes described above by slurry loop polymerization conducted at temperature conditions in the range of about 88-110° C. (190-230° F.). It is preferred that polymerization occur between about 93-109° C. (200-228° F.) and pressures of about 500-650 psig (515-665 psia). The preferred diluent in a process according to the present invention is isobutane.

In an embodiment of the invention, a blow molding resin is produced preferably having a density of about 0.944-0.958 g/cm³, more preferably 0.950-0.957 g/cm³ (ASTM D-1505) and a preferred range of I₂₂ of about 2-12 g/10 min, more preferably 3-8 g/10 min (ASTM D-1238-65T, Condition F). These characteristics may be readily achieved by one of ordinary skill in the art in possession of the present disclosure. Although the resin according to the present invention is described as a high molecular weight high density polyethylene, the molecular weight is per se not a characteristic typically focused on in HMW HDPE resins, as would be recognized by one of ordinary skill in the art. Typically HMW HDPE will have a weight average molecular weight ranging from about 100,000 g/mole to about 4,000,000 g/mole. HDPE is typically defined as having a density above about 0.940 g/cm³.

Reference will be made to the following specific example, which is not intended to be limiting.

### EXAMPLE 1

A commercial silica-supported chromium and titanium-based catalyst, C-25305™, available from The PQ Corporation, Conshohocken, Pa. was activated in the following manner.

The catalyst is placed in a fluidizing bed activating reactor of the type well-known in the art. The activating reactor comprises heating rods to heat the catalyst bed and gas inlets with preheaters. The catalyst is fluidized with dry N₂ and the temperature of the activating reactor/catalyst bed is ramped up at about 222° C./hr (400° F./hr) to 205° C. (400° F.). It is held at this temperature under a nitrogen flow of about 126 CFM (cubic feet per minute) for 4 hours and then ramped at about 195° C./hr (350° F./hr) to a hold at about 400° C. (750° F.) under a nitrogen flow of about 144 CFM. The catalyst is held in the activating reactor under these conditions for about 3.5 hours. The gas inlet preheaters are set to 450° C. (850° F.) during the period that the activating reactor temperature is held at 400° C. (750° F.) under nitrogen, and shortly before the introduction of the 20 CFM of air, the gas inlet preheaters are lowered to about 200° C. (400° F.).

Then a controlled amount of oxidant is introduced, in the form of dry air at a rate of 20 CFM, with a decrease in the nitrogen flow to approximately 122 CFM, so that the amount of oxygen in the activating reactor is at a concentration of about 2.8% by volume, while maintaining the activating reactor at about 400° C. (750° F.). A temperature spike to about 425° C. (800° F.) is observed in the reactor shortly after the partial oxygen environment is introduced, but the activating reactor temperature approaches 400° C. (750° F.) within about 90 minutes. The gas inlet preheaters remain set at about 200° C. (400° F.) during this period.

The atmosphere is then switched to 100% dry air and the temperature is ramped using both the activating reactor probe heaters and the gas inlet preheaters, at about 83° C. (150° F./hr) to a 6 hour hold at 590° C. (1100° F.) and held for 6 hours, to complete activation.

The catalyst is then cooled to about 150-205° C. (300-400° F.) under an atmosphere of air and then fluidized with nitrogen and allowed to come to room temperature.

The thus-activated catalyst is used in a slurry loop polymerization process to produce HMW HDPE resin under the conditions previously described, using in this case 1-hexene as the comonomer.

The resin has a nominal I₂₂ value (which may be referred to as Flow Rate 190/21.6 or HLMI) of 5.8 g/10 min (ASTM D-1238-65T, Condition F), a nominal density of 0.954 g/cm³ (ASTM D-1505). These values are not intended to be performance specifications but represent typical values. This resin is particularly suitable for 30- and 55-gallon drums, IBCs, and other large parts made by blow molding and/or sheet extrusion/thermoforming operations.

While the illustrative embodiments of the invention have been described with particularity, it will be understood that various other modifications will be apparent to—and can be readily made by—those skilled in the art without departing from the spirit and scope of the invention. Accordingly, it is not intended that the scope of the claims appended hereto be limited to the example and descriptions set forth herein but rather that the claims be construed as encompassing all the features of patentable novelty which reside in the present invention, including all features which would be treated as equivalents thereof by those skilled in the art to which the invention pertains.

Accordingly, while many variations of the following embodiments will suggest themselves to those skilled in this art in light of the above detailed description, particularly preferred embodiments include: (A) a process for producing a resin suitable for sheet extrusion/thermoforming and/or blow molding, said process comprising polymerizing ethylene or ethylene and an alpha-olefin comonomer comprising 3 to 10 carbon atoms, in the presence of a chromium and titanium-based catalyst activated by: (i) contacting said catalyst in a activating reactor at a temperature of between about 370-540° C. (700-1000° F.) with an atmosphere consisting essentially of an inert gas; and then (ii) introducing an oxidant into said activating reactor so that the temperature of said activating reactor does not exceed about 510° C. (950° F.); and then (iii) completing the activation of said catalyst in a activating reactor at a temperature of about 548-638° C. (1020-1180° F.) under an oxidizing atmosphere; and more particularly preferred embodiments of the sheet extrusion/thermoforming process and/or the blow molding process wherein the temperature of said activating reactor in (i) does not exceed about 450° C. (850° F.); wherein the temperature of said activating reactor in (iii) does not exceed about 450° C.° (850° F.); wherein the temperature of said activating reactor in (i) does not exceed about 400° C. (750° F.) and the temperature of said activating reactor in (iii) does not exceed about 425° C. (800° F.); wherein (iii) further comprises completing the activation at said temperature and under said oxidizing atmosphere for a period of from 1 minute to 10 hours; wherein said period in (iii) is from 4 to 7 hours; wherein said oxidizing atmosphere in (iii) is an atmosphere consisting essentially of air; wherein said oxidizing atmosphere in (iii) is an atmosphere consisting essentially of air; wherein said oxidizing atmosphere in (iii) is an atmosphere consisting essentially of air; wherein said resin has a density range of about 0.944-0.958 g/cm³ according to ASTM D-1505 and a I₂₂ in the range of about 2-12 g/10 min according to ASTM D-1238-65T, Condition F; also more preferably one or both of the following properties: wherein I₂₂ is in the range of about 3-8 g/10 min according to ASTM D-1238-65T, Condition F and/or wherein the density is in the range of about 0.950 to 0.957 g/cm³; wherein said catalyst consists essentially of chromium and titanium on a silica support; wherein said catalyst comprises about 1.0±0.5 wt. % chromium and 1.0 to 5.0 wt. % titanium, supported on silica, the weight percents based on the weight of the silica support; wherein said process occurs in a slurry loop reactor under slurry polymerization conditions; (B) a resin suitable for use in blow molding and/or sheet extrusion/thermoforming and having a density range of about 0.944-0.958 g/cm³ according to ASTM D-1505 and a I₂₂ in the range of about 2-12 g/10 min, according to ASTM 1238-65T, Condition F, further characterized as comprising the residue of a chromium and titanium-based catalyst activated by: (i) contacting said catalyst in a activating reactor at a temperature of between about 370-540° C. (700-1000° F.) with an atmosphere consisting essentially of an inert gas; and then (ii) introducing an oxidant into said activating reactor so that the temperature of said activating reactor does not exceed about 510° C. (950° F.); and then (iii) completing the activation of said catalyst in a activating reactor at a temperature of about 548-638° C. (1020-1180° F.) under an oxidizing atmosphere; and also more preferred embodiments wherein said resin has a density range of about 0.950-0.957 g/cm³ according to ASTM D-1505 and/or an I₂₂ in the range of about 3-8 g/10 min according to ASTM D-1238-65T, Condition F; wherein said resin is produced in a slurry polymerization activating reactor under slurry polymerization conditions; (C) A container suitable for holding industrial chemicals comprising the blow molding resin according to the invention, including preferred and more preferred embodiments in this paragraph; particularly wherein the container is at least 30 gallons by volume and also including as more preferred embodiments 55-gallon drums, and 100- and 300-gallon IBCs; any of the foregoing container embodiments wherein said container is comprised of the resin according to the invention, particularly a polyethylene resin having a density of 0.950-0.957 g/cm³ according to ASTM D-1505 and/or an I₂₂ in the range of about 3-8 g/10 min according to ASTM D-1238-65T, Condition F; (D) an article made by a process comprising sheet extrusion/thermoforming a resin according to the invention, especially wherein the article comprises resins as described in this paragraph; (E) an article made by a process comprising blow molding a resin according to the invention, especially wherein the article comprises resins as described in this paragraph; (F) A container suitable for holding industrial chemicals, said container made by a process comprising blow molding the resin according to the invention, particularly a resin as described in this paragraph; (G) an article comprising blow molding resin according to the invention, particularly a resin as described in this paragraph; and (H) an article made by a process comprising sheet extrusion/thermoforming a resin having a density range of about 0.944-0.958 g/cm³ (more preferably 0.950-0.057 g/cm³) according to ASTM D-1505 and a I₂₂ in the range of about 2-12 g/10 min (preferably 3-8 g/10 min) according to ASTM 1238-65T, Condition F, further characterized as comprising the residue of a chromium and titanium-based catalyst activated by; (i) contacting said catalyst in a activating reactor at a temperature of between about 370-540° C. (700-1000° F.) with an atmosphere consisting essentially of an inert gas; and then (ii) introducing an oxidant into said activating reactor so that the temperature of said activating reactor does not exceed about 510° C. (950° F.); and then (ii) completing the activation of said catalyst in a activating reactor at a temperature of about 548-638° C. (1020-1180° F.) under an oxidizing atmosphere.

Trade names used herein are indicated by a ™ symbol, indicating that the names may be protected by certain trademark rights. Some such names may also be registered trademarks in various jurisdictions.

All patents and patent applications, test procedures (such as ASTM methods), and other documents cited herein are fully incorporated by reference to the extent such disclosure is not inconsistent with this invention and for all jurisdictions in which such incorporation is permitted.

All temperatures were measured using ° F. scale and thus some additional tolerance should be allowed for rounding during conversion of these temperatures to ° C. scale, in addition to the ordinary tolerance provided for the term “about”.

When numerical lower limits and numerical upper limits are listed herein, ranges from any lower limit to any upper limit are contemplated.

1. A process for producing a resin suitable for sheet extrusion/thermoforming and/or blow molding comprising polymerizing ethylene or ethylene and an alpha-olefin comonomer comprising 3 to 10 carbon atoms, in the presence of a chromium and titanium-based catalyst activated by:
(a) contacting said catalyst in an activating reactor at a temperature of between about 370-540° C. (700-1000° F.) with an atmosphere consisting essentially of an inert gas; and then
(b) introducing an oxidant into an activating reactor so that the temperature of said reactor does not exceed about 510° C. (950° F.); and then
(c) completing the activation of said catalyst in an activating reactor at a temperature of about 548-638° C. (1020-1180° F.) under an oxidizing atmosphere.

2. The process according to claim 1, wherein the temperature of said reactor in (a) does not exceed about 450° C. (850° F.).

3. The process according to claim 1, wherein the temperature of said reactor in (b) does not exceed about 450° C.°(850° F.).

4. The process according to claim 1, wherein the temperature of said reactor in (a) does not exceed about 400° C. (750° F.) and the temperature of said reactor in (b) does not exceed about 425° C. (800° F.).

5. The process according to claim 1, wherein (c) further comprises completing the activation at said temperature and under said oxidizing atmosphere for a period of from 1 minute to 10 hours.

6. The process according to claim 5, wherein said period in (c) is from 4 to 7 hours.

7. The process according to claim 1, wherein said oxidizing atmosphere in (c) is an atmosphere consisting essentially of air.

8. The process according to claim 5, wherein said oxidizing atmosphere in (c) is an atmosphere consisting essentially of air.

9. The process according to claim 6, wherein said oxidizing atmosphere in (c) is an atmosphere consisting essentially of air.

10. The process according to claim 1, wherein said resin has a density range of about 0.944-0.958 g/cm³ according to ASTM D-1505 and a I₂₂ in the range of about 2-12 g/10 min according to ASTM D-1238-65T, Condition F.

11. The process according to claim 10, wherein I₂₂ is in the range of about 3-8 g/10 min according to ASTM D-1238-65T, Condition F.

12. The process according to claim 1, wherein said catalyst consists essentially of chromium and titanium on a silica support.

13. The process according to claim 1, wherein said catalyst comprises about 1.0±0.5 wt. % chromium and 1.0 to 5.0 wt. % titanium, supported on silica, the weight percents based on the weight of the silica support.

14. The process according to claim 1, wherein said process occurs in a slurry loop reactor under slurry polymerization conditions.

15. A resin suitable for use in blow molding and having a density range of about 0.944-0.958 g/cm³ according to ASTM D-1505 and a I₂₂ in the range of about 2-12 g/10 min according to ASTM 1238-65T, Condition F, further characterized as comprising the residue of a chromium and titanium-based catalyst activated by:
(a) contacting said catalyst in an activating reactor at a temperature of between about 370-540° C. (700-1000° F.) with an atmosphere consisting essentially of an inert gas; and then
(b) introducing an oxidant into an activating reactor so that the temperature of said reactor does not exceed about 510° C. (950° F.); and then
(c) completing the activation of said catalyst in an activating reactor at a temperature of about 548-638° C. (1020-1180° F.) under an oxidizing atmosphere.

16. The resin according to claim 15, wherein said resin has a density range of about 0.950-0.957 g/cm³ according to ASTM D-1505 and an I₂₂ in the range of about 3-8 g/10 min according to ASTM D-1238-65T, Condition F.

17. The resin according to claim 15, wherein said resin is produced in a slurry polymerization reactor under slurry polymerization conditions.

18. A container suitable for holding industrial chemicals, said container comprising the blow molding resin according to claim 15.

19. The container according to claim 18, said container selected from the group consisting of 30-gallon drums, 55-gallon drums, 100-gallon IBCs, 300-gallon and 400-gallon IBCs.

20. The container according to claim 18, wherein said article is comprised of a polyethylene resin having a density of 0.950-0.957 g/cm³ according to ASTM D-1505 and a I₂₂ in the range of about 3-8 g/10 min according to ASTM D-1238-65T, Condition F.

21. A container suitable for holding industrial chemicals, said container made by a process comprising blow molding the resin according to claim 15.

23. An article made by a process comprising blow molding a resin according to claim 15.

24. An article made by a process comprising sheet extrusion/thermoforming a resin having a density range of about 0.944-0.958 g/cm³ according to ASTM D-1505 and a I₂₂ in the range of about 2-12 g/10 min according to ASTM 1238-65T, Condition F, further characterized as comprising the residue of a chromium and titanium-based catalyst activated by:
(a) contacting said catalyst in an activating reactor at a temperature of between about 370-540° C. (700-1000° F.) with an atmosphere consisting essentially of an inert gas; and then
(b) introducing an oxidant into an activating reactor so that the temperature a polyethylene resin having a density of 0.950-0.957 g/cm³ according to ASTM D-
(c) completing the activation of said catalyst in an activating reactor at a temperature of about 548-638° C. (1020-1180° F.) under an oxidizing atmosphere.
